(19) United States
(12) Patent Application Publication
(10) Pub. No.: US 2018/0231495 A1
(43) Pub. Date: Aug. 16, 2018

(54) SENSOR ELEMENT FOR DETECTING AT LEAST ONE PROPERTY OF A MEASURING GAS IN A MEASURING GAS CHAMBER INCLUDING A GLASS CERAMIC SEAL

(71) Applicant: Robert Bosch GmbH, Stuttgart (DE)

(72) Inventors: Mohammad Masyood Akhtar, Stuttgart (DE); Stefan Henneck, Leonberg (DE)

(21) Appl. No.: 15/750,432

(22) PCT Filed: Aug. 18, 2016
(86) PCT No.: PCT/EP2016/069569

§ 371 Date: Feb. 5, 2018

(30) Foreign Application Priority Data
Aug. 20, 2015 (DE) 10 2015 215 935.3

(51) Int. Cl. G01N 27/407; C03C 3/062; C03C 3/064

(52) U.S. Cl. CPC G01N 27/4078; C03C 3/064; C03C 3/062

(57) ABSTRACT

A sensor element for detecting at least one property of a measuring gas in a measuring gas chamber, in particular for detecting a portion of a gas component in the measuring gas or a temperature of the measuring gas. The sensor element includes a first substrate, a second substrate, and a sensor chip. The sensor chip includes at least one solid electrolyte diaphragm, a first electrode, and a second electrode. The first substrate and the second substrate are connected to each other via at least one glass ceramic. The glass ceramic is manufactured from a material which includes at least SiO₂, MgO, Al₂O₃, as well as ZnO and/or B₂O₃.

### BACKGROUND INFORMATION

A plurality of sensor elements and methods for detecting at least one property of a measuring gas in a measuring gas chamber are available. In this case, these may be, in principle, arbitrary physical and/or chemical properties of the measuring gas, where one or multiple properties may be detected. The present invention is described in the following, in particular with reference to a qualitative and/or quantitative detection of a portion of a gas component of the measuring gas, in particular with reference to a detection of an oxygen portion in the measuring gas part. The oxygen portion may be detected, for example, in the form of a partial pressure and/or in the form of a percentage. Alternatively or additionally, other properties of the measuring gas are also detectable, however, such as, for example, the temperature.

Ceramic sensor elements, in particular, are available which are based on the use of electrolytic properties of certain solids, i.e., on ion-conducting properties of these solids. These solids may be, in particular, ceramic solid electrolytes, such as, for example, zirconium dioxide (ZrO₂), in particular yttrium-stabilized zirconium dioxide (YSZ), and scandium-doped zirconium dioxide (ScSZ), which may contain small admixtures of aluminum oxide (Al₂O₃) and/or silicon dioxide (SiO₂).

For example, such sensor elements may be designed as so-called lambda sensors or as conventional nitrogen oxide sensors, described, for example, in K. Reif, Deitsche, K-H. et al., Kraftfahrtechnisches Taschenbuch, Springer Vieweg, Wiesbaden, 2014, pages 1338-1347. With the aid of broadband lambda sensors, in particular with the aid of planar broadband lambda sensors, the oxygen concentration in the exhaust gas, for example, may be determined within a large range and, therefore, the air-fuel ratio in the combustion chamber may be deduced. The air ratio λ (lambda) describes this air-fuel ratio. Nitrogen oxide sensors determine the concentration of both nitrogen oxide as well as oxygen in the exhaust gas.

### SUMMARY

The present invention is directed to the finding that there is recently a need for smaller sensor elements. Such sensor elements may be based on a sensor chip including a solid electrolyte diaphragm. Such a sensor chip is connected to a support element.

Despite the advantages of the conventional sensor elements, they have potential for further improvement. For example, it is difficult to connect the sensor chip to the one support element made of a material other than the material of the chip with the aid of bonding, in particular, conventional wafer-bonding methods. Typical glasses for wafer bonding or wafer sealing are low-melting-point glasses which are frequently made of PbO, B₂O₃, Bi₂O₃, P₂O₅, ZnO including very little SiO₂ and which have extremely low softening and melting temperatures of, frequently, 350° C. to 450° C.

Such glasses are not suitable, however, for permanently stable bond connections for use in the exhaust-gas area of internal combustion engines. In the field of the present invention, the glass must therefore be stable, in particular, also in the presence of vaporous portions of sulfuric acid, hydrochloric acid, and sodium hydroxide solution in the exhaust gas. In addition, the glass must also be stable under temporarily strongly reductive conditions. Ions of alkali metal oxides are particularly problematic, since they stop the bonding of the tetrahedral SiO₄ in the glass network structure due to their monovalent charge and, at an elevated temperature, may migrate in the presence of an electrical potential. When a voltage is applied, the ions concentrate at the negatively charged pole. The concentration at the negative pole, with the simultaneous presence of humidity and a certain temperature, locally increases the pH value. At a pH value greater than 12, the silicon dioxide dissolves and forms alkali silicates. Such silicates, such as, for example, sodium silicates, have an increasing solubility in water, even at room temperature, as the portion of Na₂O (sodium oxide) increases. SiO₂ dissolved in this way may deposit again at another point and the alkali ions are transported further. The product is gelatinous silica which could result in a sealing, for example on the solid electrolyte layer, and may lower the gas sensitivity in such a way that the sensor function is no longer ensured.

A need may therefore arise to provide a sensor element, in the case of which a first substrate and a second substrate are connected to each other with the aid of a glass ceramic that is particularly resistant and mechanically as well as chemically stable even at high pH values, in the presence of a high moisture content, at high temperatures, and in the presence of electrical fields.

In accordance with the present invention, a sensor element for detecting at least one property of a measuring gas in a measuring gas chamber is provided, which may at least largely avoid the disadvantages of conventional sensor elements. In particular, a sensor element is provided, the glass of which is stable even at high temperatures, high moisture contents, and in the presence of electrical fields.

An example sensor element according to the present invention for detecting at least one property of a measuring gas in a measuring gas chamber, in particular for detecting a portion of a gas component in the measuring gas or a temperature of the measuring gas, includes a first substrate, a second substrate, and a sensor chip. The sensor chip includes at least one solid electrolyte diaphragm, a first electrode, and a second electrode. The first substrate and the second substrate are connected to each other via at least one glass ceramic. The glass ceramic is manufactured from a material which includes at least silicon dioxide (SiO₂), magnesium oxide (MgO), aluminum oxide (Al₂O₃), as well as zinc oxide (ZnO) and/or boron oxide (B₂O₃). As a result, the glass ceramic is stable under conditions including high moisture content and high temperature. In this way, such a glass ceramic has thermal properties which are similar to those of the substrates. For example, the thermal expansion coefficients of the glass ceramic differ from those of the substrates across a temperature range from 0° C. to 900° C. so negligibly that no thermally induced mechanical stresses occur in the material of the glass ceramic. In addition, the associated glass, as a precursor, i.e., before crystallization into the glass ceramic, has improved processing properties with respect to flow properties and cross-linking properties.

The material of the glass ceramic may also include titanium dioxide (TiO₂). The portion of the zinc oxide in the material may be from 0 weight percent to 65 weight percent. The portion of the boron oxide in the material may be from 0 weight percent to 40 weight percent. Glass as the precursor of the glass ceramic including zinc oxide and/or boron oxide has a low viscosity at and above its melting temperature, even without an alkali oxide portion and may therefore advantageously wet the silicon-dioxide-containing surfaces to be connected.

The first substrate and the second substrate may be bonded to each other. Preferably, the first substrate and the second substrate are connected to each other in a hermetically sealed manner. Since glass including zinc oxide and/or boron oxide has improved flow properties, it may be introduced, in a planar manner, between the substrates to be connected, so that, as a result, a particularly good hermetic seal may be achieved.

The glass ceramic may be situated and designed as a seal between the first substrate and the second substrate. The glass ceramic may include at least one getter. The getter may include, for example, Ta₂O₅ (tantalum(V) oxide) and/or WO₃ (tungsten trioxide or tungsten(VI) oxide). As a result, alkali ions, such as, for example, Na⁺, may be captured, so that they do not react with SiO₂ from the glass ceramic or the substrate. Alternatively or additionally, the getter may include further suitable oxides of rare earth metals or transition metals, such as, for example, Nb₂O₅ (niobium(V) oxide) or Y₂O₃ (yttrium oxide). As a result, phosphates (PO₄³⁻), for example, may be captured and may form stable reaction products such as, for example, YPO₄.

The sensor chip may include the first substrate and/or the second substrate. In other words, the sensor chip may also be formed from a single substrate or from a connection of at least two substrates. This may be advantageous, since the possible uses with respect to the joining partners are increased with the aid of the glass ceramic. For example, a layered design of substrates or a connection to further sensor chips may be implemented in this way.

The sensor element may also include a support element. The support element may include the first substrate and the sensor chip may include the second substrate. As a result, the sensor chip may be connected to the support element in a manner which is permanently stable across a wide temperature range. The first substrate and the second substrate may be manufactured from the same material or from different materials. The glass ceramic according to the present invention is therefore particularly well suited for connecting materials which differ in terms of chemical composition but which are similar in terms of the thermal expansion properties, even for use in aggressive environmental conditions. In particular, the glass ceramic is also stable under changing temperatures, such as, for example, thermal cycles, since no thermally induced stresses are introduced into the material.

For example, the first substrate is manufactured from a gas-tight ceramic including the main components mullite and an element selected from the group cordierite and indialite (indialite is a high-temperature modification of cordierite), a thermal expansion coefficient of the ceramic being adapted, and preferably precisely adapted, to a thermal expansion coefficient of the second substrate of the sensor chip. In this case, when both cordierite and indialite are present, the sum of the portions of these two components may also be added together. This sum may then be counted, within the scope of the application, as the total portion of cordierite.

In one advantageous composition of the ceramic, the portion of cordierite or of indialite is in a range from 10 weight percent to 50 weight percent and the portion of mullite is in a range from 30 weight percent to 90 weight percent. Particularly advantageously, the portion of cordierite or of indialite is in a range from 25 weight percent to 40 weight percent and the portion of mullite is in a range from 60 weight percent to 75 weight percent.

An adaptation of the thermal expansion coefficients is understood to mean, within the scope of the present invention, that the materials involved are manufactured in such a way that their thermal expansion coefficients do not differ by more than 15% and preferably not more than 10%. As a result, a composite material is utilized for the first substrate, the thermal expansion coefficient of which differs only negligibly from the thermal expansion coefficient of the substrate of the sensor chip. Since the glass ceramic also has an adapted thermal expansion coefficient due to its composition, the two substrates and the glass ceramic are very similar in terms of their thermal expansion properties, so that thermally induced stresses are avoided particularly well.

A substrate is understood to mean, within the scope of the present invention, an object having a plate-shaped, cube-shaped, or rectangular-shaped design or any other type of geometric design and includes at least one flat surface and is manufactured from a ceramic material, a metallic material, a semiconductor material, or combinations thereof.

A glass is understood to mean, within the scope of the present invention, an amorphous solid which includes at least 10 weight percent of silicon dioxide. During melting and the connecting of the joining partners, the glass is mostly converted into crystalline silicates, so that it is a glass ceramic in the final state.

A glass frit is understood to mean, within the scope of the present invention, a powdered glass.

A support element is understood to mean, within the scope of the present invention, any component, in principle, which is suitable for supporting a sensor chip.

A getter is understood to mean, within the scope of the present invention, a chemically reactive material which is used for bonding certain electrically charged particles, in particular ions and salts. On the surface of a getter, the particles enter into a direct chemical bond with the atoms of the getter material or the particles are fixedly held via sorption. In this way, particles are “captured.” Within the scope of the present invention, getters are utilized which fixedly incorporate alkalis, in the form of their ions, such as, for example, Na⁺ or also PO₄³⁻, as mainly critical components of exhaust gas in internal combustion engines, in the crystal lattice of the getter oxide, with the corresponding oxygen as the “binding partner,” and then form stable stoichiometric compounds.

A solid electrolyte is understood to mean, within the scope of the present invention, a body or an object having electrolytic properties, i.e., having ion-conducting properties. In particular, the solid electrolyte may be designed as a solid electrolyte diaphragm or from multiple solid electrolyte diaphragms. A diaphragm is understood to mean, within the scope of the present invention, a uniform mass having a planar extension of a certain height. A diaphragm is therefore a three-dimensional body, in which measurements of two dimensions, which represent the planar design of the diaphragm, are considerably greater than a measurement of the third dimension which represents the height of the diaphragm.

An electrode is understood to mean, in general, within the scope of the present invention, an element which is capable of contacting the solid electrolyte in such a way that a current may be maintained by way of the solid electrolyte and the electrode. The electrode may therefore include an element, on which the ions may be inserted into the solid electrolyte and/or removed from the solid electrolyte. The electrodes typically include a noble metal electrode which may be mounted, for example as a metal-ceramic electrode, on the solid electrolyte or which may be connected to the solid electrolyte in another way. Typical electrode materials are platinum-cermet electrodes. Other noble metals, such as, for example, gold or palladium, are also usable, in principle.

A heating element is understood to mean, within the scope of the present invention, an element for heating the solid electrolyte and the electrodes to at least their functional temperature and, preferably, to their operating temperature. The functional temperature is the temperature at which the solid electrolyte becomes conductive for ions, and is approximately 350° C. This differs from the operating temperature which is the temperature at which the sensor element is usually operated and which is higher than the functional temperature. The operating temperature may be, for example, 700° C. to 950° C. The heating element may include a heating area and at least one supply path.

A heating area is understood to mean, within the scope of the present invention, the area of the heating element which, in the layered design, overlaps an electrode along a direction perpendicular to the surface of the sensor element. The heating area usually heats up during operation by a greater extent than the supply path, so that these may be differentiated. The different heating may be implemented, for example, in that the heating area has a greater electrical resistance than the supply path. The heating area and/or the supply path are/is designed, for example, as an electrical resistance path and heat/heats up upon application of a voltage. The heating element may be manufactured, for example, from a platinum-cermet or a platinum layer.

The present invention provides a glass or a glass ceramic which may be manufactured free from sodium oxide, lithium oxide, and potassium oxide. The glass is compatible with silicon, silicon oxide, silicon carbide, silicon nitride, and silicon oxynitride, due to similar expansion coefficients and the silicon dioxide, which always forms on the surface, by way of which the wetting of the glass melt takes place. The glass or the glass ceramic is likewise compatible with cordierite, mullite, or mixtures thereof. In addition, the glass is compatible, even at higher temperatures, with quartz glass, Pyrex, and other silicate-based compositions, such as, for example, glass ceramics, the thermal expansion coefficient of which has a value similar to that of silicon.

### BRIEF DESCRIPTION OF THE DRAWINGS

Further optional details and features of the present invention result from the following description of preferred exemplary embodiments of the present invention, which are schematically represented in the FIGURE.

FIG. 1 shows a perspective view of a sensor element according to the present invention.

### DETAILED DESCRIPTION OF EXAMPLE EMBODIMENTS

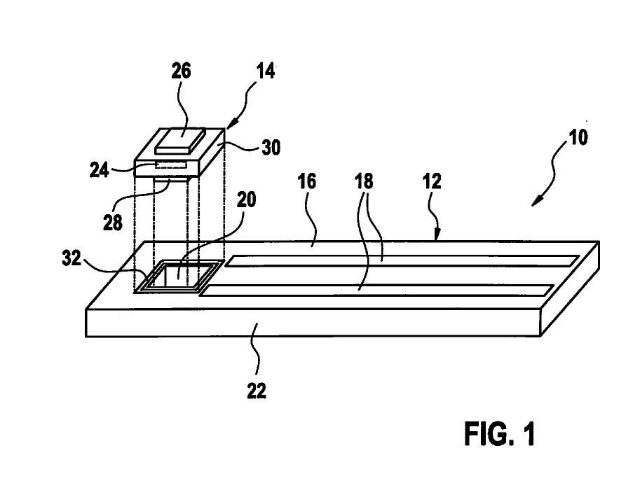

FIG. 1 shows a perspective view of a sensor element 10 according to the present invention. Sensor element 10 according to the present invention may be utilized for detecting physical and/or chemical properties of a measuring gas, where one or multiple properties may be detected. The present invention is described below, in particular with reference to a qualitative and/or quantitative detection of a gas component of the measuring gas, in particular with reference to a detection of an oxygen portion in the measuring gas. The oxygen portion may be detected, for example, in the form of a partial pressure and/or in the form of a percentage. In principle, however, other types of gas components are also detectable, such as, for example, nitrogen oxides, hydrocarbons, and/or hydrogen. Alternatively or additionally, however, other properties of the measuring gas are also detectable. The present invention is usable, in particular, in the field of automotive engineering, so that the measuring gas chamber may be, in particular, an exhaust gas system of an internal combustion engine and the measuring gas may be, in particular, an exhaust gas.

Sensor element 10 according to the present invention includes a support element 12 and a sensor chip 14. At least one electrical line 18 is situated on an upper face of support element 12 for the electrical contacting of sensor chip 14. Electrical line 18 may be designed as a strip conductor. Two electrical lines 18 are provided, for example. Support element 12 also includes a recess 20, in which or over which sensor chip 14 may be at least partially situated. In this case, recess 20 is designed in such a way that, due to recess 20, a hollow space is formed between sensor chip 14 and support element 12, which is filled with a reference gas or, in general, a reference having a known composition. Support element 12 includes a first substrate 22. Sensor chip 14 includes a solid electrolyte diaphragm 24, a first electrode 26, and a second electrode 28. First electrode 26 and second electrode 28 are situated, for example, on opposite sides of solid electrolyte diaphragm 24 and are electrically connected to lines 18, for example with the aid of bonding wires which are not shown in greater detail. In other specific embodiments, first electrode 26 and second electrode 28 may also be situated on the same side of solid electrolyte diaphragm 24, for example one of the two electrodes being plated-through to the other side of solid electrolyte diaphragm 24 or being connected to the other side by way of a portion which has been made electrically conductive via doping, for example, or by way of a via. Sensor chip 14 also includes a second substrate 30.

First substrate 22 may be a ceramic or a silicon wafer. Similarly, second substrate 30 may be a ceramic or, preferably, a silicon wafer. First substrate 22 and second substrate 30 are connected to each other via at least one glass ceramic 32. In particular, first substrate 22 and second substrate 30 are connected to each other in a hermetically sealed manner. In this way, first substrate 22 and second substrate 30 are bonded to each other with the aid of glass ceramic 32. In accordance with the aforementioned, first substrate 22 and second substrate 30 may be manufactured from the same material or from different materials. In principle, glass 32 is manufactured from a material which includes zinc oxide (ZnO) and/or boron oxide (B₂O₃). The portion of zinc oxide in the material may be, in this case, from 0 weight percent to 65 weight percent and, preferably from 15 weight percent to 45 weight percent, and the portion of boron oxide in the material may be from 0 weight percent to 40 weight percent and, preferably, from 0 weight percent to 15 weight percent. Further components of the material for the glass ceramic are silicon dioxide (SiO₂) with 10 weight percent to 50 weight percent and, preferably, 20 weight percent to 45 weight percent, magnesium oxide (MgO) with 1 weight percent to 20 weight percent and, preferably, 3 weight percent to 15 weight percent, aluminum oxide (Al₂O₃) with 1 weight percent to 40 weight percent and, preferably, 3 weight percent to 20 weight percent, titanium dioxide (TiO₂) with 0 weight percent to 20 weight percent and, preferably, 0 weight percent to 20 weight percent and, preferably 0 weight percent, i.e., except for technically unavoidable impurities, up to 5 weight percent, and, optionally, alkali metal oxides, such as lithium oxide, sodium oxide, and potassium oxide, cumulatively with 0 weight percent to 30 weight percent and, in particular, 0 weight percent to 7 weight percent. Within the scope of the present invention, a glass or a glass ceramic is preferred, which is manufactured from a material without alkali metal oxides. A small portion of alkali metal oxide may be introduced as an impurity, in a technically unavoidable way, due to the use of low-cost raw materials, since the impurities may be rendered harmless via the getter effect of the added oxides. Specific exemplary compositions of the glass are indicated below. The units are weight percent.

### Example 1

| | |
|---|---|
| SiO₂ | 32.11 |
| MgO | 9.21 |
| Al₂O₃ | 13.51 |
| TiO₂ | 0.69 |
| ZnO | 35.70 |
| B₂O₃ | 0.00 |
| Alkali metal oxides | 8.78 |
| (Li₂O, Na₂O, K₂O) | |

### Example 2

| | |
|---|---|
| SiO₂ | 35.69 |
| MgO | 8.11 |
| Al₂O₃ | 9.94 |
| TiO₂ | 0.00 |
| ZnO | 46.26 |
| B₂O₃ | 0.00 |
| Alkali metal oxides | 0.00 |
| (Li₂O, Na₂O, K₂O) | |

### Example 3

| | |
|---|---|
| SiO₂ | 34.82 |
| MgO | 3.62 |
| Al₂O₃ | 24.72 |
| TiO₂ | 0.00 |
| ZnO | 0.00 |
| B₂O₃ | 36.84 |
| Alkali metal oxides | 0.00 |
| (Li₂O, Na₂O, K₂O) | |

### Example 4

| | |
|---|---|
| SiO₂ | 31.48 |
| MgO | 9.03 |
| Al₂O₃ | 13.25 |
| TiO₂ | 0.68 |
| ZnO | 25.01 |
| B₂O₃ | 11.94 |
| Alkali metal oxides | 8.61 |
| (Li₂O, Na₂O, K₂O) | |

### Example 5

| | |
|---|---|
| SiO₂ | 35.69 |
| MgO | 8.11 |
| Al₂O₃ | 9.94 |
| TiO₂ | 0.00 |
| ZnO | 46.26 |
| B₂O₃ | 0.00 |
| Alkali metal oxides | 0.00 |
| (Li₂O, Na₂O, K₂O) | |

The glass ceramic or its material may be prepared as follows for the manufacture of sensor element 10. The aforementioned components of the material of the glass are weighed out in accordance with the indicated weights and are ground with each other in order to be homogenized. The mixture manufactured in this way is melted, for example in an electrically heated furnace, and, subsequent thereto, the melt formed in this way is quickly cooled, for example by emptying the crucible within five minutes. The cooling may take place with the aid of a coolant. For example, the molten glass is added to flowing water, in a controlled manner, as a thin stream of melt and, after quenching, is dried. In this way, an amorphous, coarse-grained glass frit is manufactured, which is ground in a grinding process to particle sizes, for example in the range from d50=5 μm to 25 μm.

The glass frit formed in this way is then applied, for example in the form of a glass paste, between first substrate 22 and second substrate 30, in order to form a composite. The composite formed in this way is then heated to a bonding temperature, at which the glass frit has a viscosity which is sufficiently low in order to flow and to bond first substrate 22 and second substrate 30 to each other. During the melting process, a crystallization of silicate phases sets in, which takes place slowly enough to allow a hermetic joining of the substrates and the consolidation of the glass layer to take place, but fast enough to achieve an economically acceptable temperature treatment duration, for example a holding time of 1 hour or less at the crystallization temperature.

Particularly advantageous glass compositions are formed during the crystallization by the zinc silicate (Zn₂SiO₄), magnesium aluminum silicate (MgAl₂Si₃O₁₀), or cordierite (Mg₂Al₄Si₅O₁₈) phases which, due to their low thermal expansion coefficients, form a glass ceramic, together with the remaining amorphous residual glass phase, which has the thermal expansion of silicon as well as a thermal load capacity of up to at least 900° C., without softening. This is effectuated by way of the high portion of the crystalline silicates which themselves have considerably higher melting points than the starting glass, for example, zinc silicate (Zn₂SiO₄): ˜1500° C.

Glass ceramic 32 may be situated or may function as a seal between first substrate 22 and second substrate 30. Glass ceramic 32 includes at least one getter. The getter includes T₂O₅ and/or WO₃. The getter may also include further suitable oxides of the rare earth metals or transition metals, such as, for example, Nb₂O₅ or Y₂O₃. The getter may be applied as a paste between first substrate 22 and second substrate 30. In this way, for example, the glass and the getter are manufactured separately as pastes and, subsequent thereto, are mixed in a suitable ratio. Alternatively, the glass and tantalum oxide (Ta₂O₅) or tungsten oxide (WO₃) are prepared as powder, are weighed out with each other in a ratio of, for example, 90:10, and mixed, and are then prepared with the necessary organic additives to form a paste. The paste, which has been manufactured in this way, is then applied between first substrate 22 and second substrate 30. Alternatively, it is possible to provide an inner layer with glass ceramic 32 without the getter, which is enclosed by an outer layer including glass ceramic 32 and the getter. Alternatively, the getter may be provided separately as a layer around glass ceramic 32.

1-10. (canceled)

11. A sensor element for detecting at least one property of a measuring gas in a measuring gas chamber, the sensor element being for one of detecting a portion of a gas component in the measuring gas or detecting a temperature of the measuring gas, the sensor element comprising:
a first substrate;
a second substrate; and
a sensor chip including at least one solid electrolyte diaphragm, a first electrode, and a second electrode;
wherein the first substrate and the second substrate are connected to each other with the aid of at least one glass ceramic, the glass ceramic being manufactured from a material which includes at least SiO₂, MgO, and Al₂O₃, and further includes at least one of ZnO and B₂O₃.

12. The sensor element as recited in claim 11, wherein a portion of the ZnO in the material is from 0 weight percent to 65 weight percent and a portion of the B₂O₃ in the material is from 0 weight percent to 40 weight percent.

13. The sensor element as recited in claim 11, wherein the first substrate and the second substrate are bonded to each other in a hermetically sealed manner, and are integrally joined.

14. The sensor element as recited in claim 11, wherein the glass ceramic is designed as a seal between the first substrate and the second substrate.

15. The sensor element as recited in claim 11, wherein the glass ceramic includes at least one getter.

16. The sensor element as recited in claim 15, wherein the getter includes at least one element selected from the group made up of Ta₂O₅, WO₃, Nb₂O₅ and Y₂O₃.

17. The sensor element as recited in claim 11, wherein the sensor chip includes at least one of the first substrate and the second substrate.

18. The sensor element as recited in claim 11, further comprising:
a support element, the support element including the first substrate;
wherein the sensor chip includes the second substrate.

19. The sensor element as recited in claim 11, wherein the first substrate and the second substrate are manufactured from the same material.

20. The sensor element as recited in claim 11, wherein the first substrate and the second substrate are manufactured from different materials.

21. The sensor element as recited in claim 18, wherein the first substrate is manufactured from a gas-tight ceramic including as main components mullite and an element selected from the group cordierite and indialite, a thermal expansion coefficient of the ceramic being adapted to a thermal expansion coefficient of the second substrate of the sensor chip.
